(19) United States
(12) Patent Application Publication
(10) Pub. No.: US 2002/0105199 A1
(43) Pub. Date: Aug. 8, 2002

(54) Tire manipulating apparatus

(76) Inventors: Thomas Formanek, Britt, IA (US); Steven Schneiders, Clear Lake, IA (US)

Correspondence Address: Wm. A. VanSanten, WOOD, PHILLIPS, VAN SANTEN, CLARK & MORTIMER, SUITE 3800, 500 WEST MADISON STREET, CHICAGO, IL, 60661, US

(21) Appl. No.: 09/778,560

(22) Filed: Feb. 7, 2001

(51) Int. Cl. B66C 1/18

(52) U.S. Cl. 294/74

(57) ABSTRACT

An inexpensive tire manipulating apparatus includes a generally C-shaped frame having an elongated base and two spaced arms extending to one side of the base at the respective ends of the base. A removable retaining element extends between the arms in spaced relation to the base and a sling is suspended from the base. A mounting element for attachment to a crane boom is located mid-way between the ends of the frame base and allows the apparatus to be advanced toward or moved away from a tire from the side, rather than from above, to avoid damaging fenders overlying the tires on a vehicle to be serviced.

### FIELD OF THE INVENTION

This invention relates to tire manipulating apparatus and more particularly, tire manipulating apparatus for handling large tires such as those employed on farm tractors and combines and is usable with single or dual wheels.

### BACKGROUND OF THE INVENTION

Farm tractors and combines are increasingly being made in larger sizes. As the size of such vehicles has been increased, it has also been necessary to increase the size of the tires employed on such vehicles to provide the capability for carrying increased loads. As a result, there are vehicles in existence which are provided with pneumatic tires having diameters well in excess of several feet and weighing several thousand pounds.

Such tires, as any other type of tire, require servicing but due to their bulk and weight, a great deal of effort is required. For example, substantial difficulty is encountered in demounting such tires from the vehicles, manipulating such tires during servicing when they are off of the vehicles, and remounting the tires when servicing is complete.

In the past there have been two basic methods of removing and handling such tires on farm tractors and combines.

The first method involves the use of a tire sling. The tire sling is suspended on a hook, which is located at the tip of an extension boom of a crane. To remove a tire the crane hook mounting the tire sling is moved to a location directly above the tire. The sling is moved under the tire and drawn taut. The tire is then unbolted from the vehicle and moved to a desired location through use of the crane. Unfortunately, many of today's new tractors and combines utilize a fender above the wheels. Such a tire sling becomes useless and impractical since it is difficult to move the crane extension boom and sling under the fenders and attempts to do so can very easily damage the fenders.

The second method of removing a tire is by using a tire manipulating apparatus especially designed for the purpose. Representative disclosures of such include commonly assigned Cotton U.S. Pat. No. 4,051,966, Cotton U.S. Pat. No. 3,970,342 and U.S. Pat. No. 3,927,778 to Zrostlik. It will be immediately recognized that apparatus of this type is large, heavy and complicated, requiring a hydraulic system and a large vehicle on which it is mounted. It is expensive to manufacture as well as to move from one location to another. Consequently, while very practical for manipulating the tires on large off the road vehicle, such as trucks used in mining operations, it is prohibitively expensive to use in servicing smaller vehicles such as agricultural tractors and combines.

The present invention is directed to overcoming one or more of the above problems.

### SUMMARY OF THE INVENTION

It is the principal object of the invention to provide a new and improved tire manipulating apparatus. More specifically, it is an object of the invention to provide a tire manipulating apparatus of light weight and simple, economical construction usable with a small truck mounted crane for the mounting and demounting of a tire from a tractor or a combine without damaging components, such as fenders, on the vehicle on which the tire is located.

An exemplary embodiment of the invention achieves the foregoing object in a construction including a generally C-shaped frame having an elongated base and two spaced arms extending to one side of the base at locations at respective ends of the base. The base, at approximately its midpoint, is adapted to be connected to the boom of a crane or the like. A flexible cradle is adapted to receive and support a lower part of a tire and has opposite ends. There is a connecting element at each end of the cradle connecting the associated cradle end to a respective one of the arms on the frame.

Preferably, a removable retaining element extends between the arms in spaced relation to the base. It is above the cradle and adapted to engage and retain an upper part of a tire supported in the cradle. In one embodiment, the retaining element is a flexible strap that is detachably connected to at least one of the arms.

At least one of the connecting elements is an adjustable connecting element. Preferably, the adjustable connecting element includes a chain and a chain tightener.

In one embodiment, the base is a relatively long metallic tube and each of the arms is a relatively short metallic tube secured to a respective end of the relatively long metallic tube at about 90° with respect thereto. There is a mounting fixture on the relative long metallic tube at its midpoint.

In a preferred embodiment, the cradle is a webbed fabric sling having a spreader bar at each of the opposite ends.

The resulting tire manipulating apparatus not only is light weight and usable with small cranes mounted on relatively small vehicles but also may be fabricated relatively inexpensively without the cost of a dedicated hydraulic system and is easy to use.

Other objects and advantages will become apparent from the following specification taken in conjunction with the accompanying drawings.

### DESCRIPTION OF THE DRAWINGS

FIG. 1 is a perspective view of one embodiment of the apparatus of the present invention;

FIG. 2 is a perspective view of the apparatus of the present invention rotated approximately 90° from the illustration of FIG. 1 and additionally showing a tire supported by a sling; and

FIG. 3 is an enlarged, exploded fragmentary view of the end of a retaining strap, the end of a short tube and a sling mounting chain employed in an exemplary embodiment of the invention.

### DESCRIPTION OF THE PREFERRED EMBODIMENT

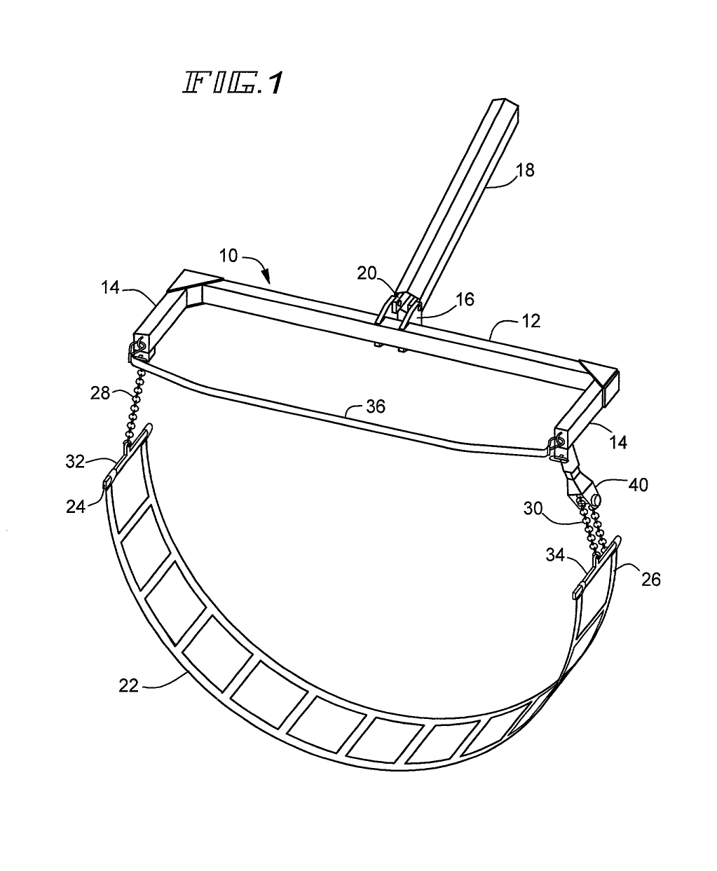

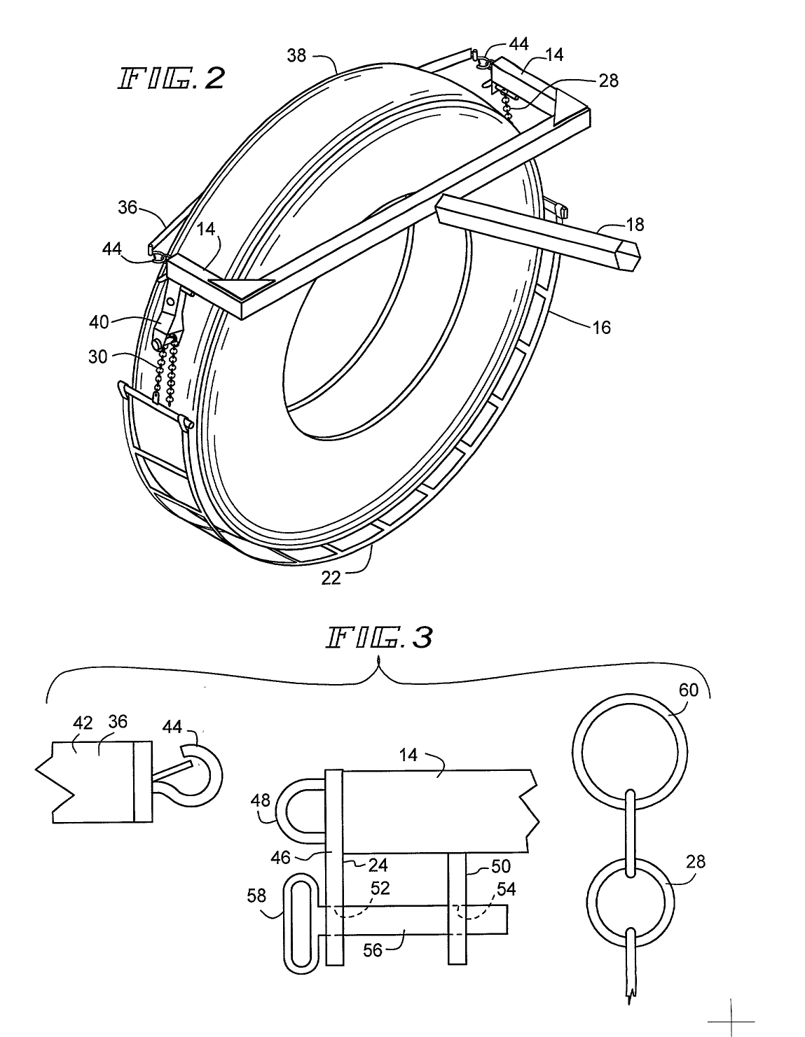

An exemplary embodiment of a tire manipulating apparatus made according to the invention is illustrated in FIGS. 1 and 2 and with reference thereto is seen to include a generally C-shaped frame, generally designated 10. The frame 10 includes a base 12 formed of a relatively long metallic tube of rectangular or square cross-section. On each end of the base 12, two short arms 14 are located. The arms are also made of metallic tube of rectangular or square cross-section and project away from the base in the same direction. Each has one end fixedly connected to a respective end of the base 12 at about 90° with respect thereto.

A mounting fixture 16 formed of two apertured spaced plates is welded or otherwise attached to the base 12 at its midpoint. The C-shaped frame 10 may thus be bolted directly to an extension boom 18 of a crane as, for example, assuming that the tip 20 of the extension boom includes apertures that will align with those in the two plates forming the mounting fixture 16. The attachment is such that the frame 10 cannot move relative to the extension boom 18.

As seen in FIGS. 1 and 2, a webbed sling 22, formed of nylon fabric or the like, has opposite ends 24, 26 connected to the arms 14 by chains 28 and 30 respectively. The chain 28 has one end connected to a spreader bar 32 at one end of the sling 22 while the chain 30 has an end connected to a spreader bar 34 at the other end of the sling 22. The basic structure of the device is completed by the presence of a retainer 36 that removably extends between the ends of the arms 14 remote from the base 12.

As seen in FIG. 2, a tire 38 is suspended in the sling 22 and located between the arms 14 which are at an elevation somewhat below the top of the tire 38. The tire is retained in the position illustrated in FIG. 2 by the presence of the retainer 36. As a consequence, the tire is held against the base 12 of the frame 10 by the retainer 36 and by the presence of the arms 14. Because the arms 14 are below the top of the tire 36, it will be appreciated that they may be moved horizontally toward a tire and beneath the fenders overlying the tire without contacting and causing damage to fenders on the vehicle. Once this has occurred, the retainer 36 may be put in place, the wheel or tire loosened from a rim or from the vehicle and then withdrawn therefrom by retracting the extension boom 18. Preferably, the retainer 36 is a flexible strap made of, for example, nylon.

Further, it is desirable to provide a means for adjusting the sling 22. This is accomplished by placing the chain 30 through a conventional chain tightener 40 (FIGS. 2 and 3). As is well known, simply by pulling on the free end of the chain 30 and drawing it through the chain tightener, the loop defined by the sling 22 may be reduced. Conversely, by appropriately orienting the free end of the chain 30 with respect to the chain tightener 40, the chain 30 may be fed through the chain tightener 40 to enlarge the loop provided by the sling 22. In this way, different sizes of wheels or tires may be readily accommodated.

FIG. 3 illustrates certain details of a preferred embodiment of a tire manipulating apparatus made according to the invention. For example, the retainer 36 is shown in the form of a fabric strap 42 provided with snap hooks 44 of a conventional construction at each end of the strap 42. The ends of each of the arms 14 remote from the base 12 include a depending plate 46 welded to the associated arm 14 and which mounts an eye 48 for removably receiving an associated hook 44. Thus, manipulation of the retainer 36 is made relatively simple.

Just inboard of the depending plate 46, a further plate 50 is welded to the under side of each arm 14. The plates 46 and 50 include aligned apertures 52 and 54 respectively for receiving a retaining pin 56. The pin 56 has, at one end, a finger receiving loop 58 that may be grasped to assist in withdrawing the pin 56 from the apertures 52, 54.

An end link 60 on an end of the chain 28 or a suitable yoke (not shown) on the chain tightener 40 may be impaled by the pin 56 on the associated arm 14 to assemble the sling to the frame 10.

From the foregoing, it will be appreciated that a tire manipulating apparatus made according to the invention is ideally suited for use with truck mounted cranes in the course of servicing tires for vehicles such as farm tractors and combines. The tire manipulating apparatus is inexpensive to fabricate and simple in construction. Yet the same may be readily employed to remove tires or wheels from vehicles of the sort mentioned that are provided with fenders overlying the wheels without making damaging contact with such fenders. Consequently, the simplicity and inexpensive construction of conventional sling type systems is maintained while the ability to grasp a tire from the side rather than overhead to avoid damage to vehicle fenders or the like usually found in more complex and expensive equipment is present as well.

I claim:

1. A tire manipulating apparatus comprising:
a generally C-shaped frame having an elongated base and two spaced arms extending to one side of the base at locations at respective ends of the base, said base, at approximately its midpoint, being adapted to be connected to the boom of a crane or the like;
a flexible cradle adapted to receive and support a lower part of a tire and having opposite ends; and
a connecting element at each end of said cradle and connecting the associated cradle end to a respective one of the arms on said frame.

2. The tire manipulating apparatus of claim 1 further including a removable retaining element extending between said arms in spaced relation to said base and above said cradle and adapted to engage an upper part of a tire supported in said cradle.

3. The tire manipulating apparatus of claim 2 wherein said retaining element is a flexible strap that is detachably connected to at least one of said arms.

4. The tire manipulating apparatus of claim 1 wherein at least one of said connecting elements is an adjustable connecting element.

5. The tire manipulating apparatus of claim 4 wherein said adjustable connecting element includes a chain and a chain tightener.

6. The tire manipulating apparatus of claim 1 wherein said base is a relatively long metallic tube and each of said arms is a relatively short metallic tube secured to a respective end of said relatively long metallic tube at about 90° with respect thereto; and a mounting fixture on said relatively long metallic tube at its midpoint.

7. The tire manipulating apparatus of claim 1 wherein said cradle is a webbed fabric sling having a spreader bar at each of said opposite ends.

8. A tire manipulating apparatus comprising:
a generally C-shaped frame having an elongated base and two spaced arms extending to one side of the base at locations at respective ends of the base, said base, at approximately its midpoint, being adapted to be connected to the boom of a crane or the like;
a flexible cradle adapted to receive and support a lower part of a tire and having opposite ends;
a connecting element at each end of said cradle and connecting the associated cradle end to a respective one of the arms on said frame;
a removable retaining element extending between said arms in spaced relation to said base and above said cradle and adapted to engage an upper part of a tire supported in said cradle, said retaining element being a flexible strap that is detachably connected to at least one of said arms;
at least one of said connecting elements being an adjustable connecting element, said adjustable connecting element including a chain and a chain tightener;
said base being a relatively long metallic tube and each of said arms being a relatively short metallic tube secured to a respective end of said relatively long metallic tube at about 90° with respect thereto, and a mounting fixture on said relatively long metallic tube at its midpoint; and
said cradle being a webbed fabric sling and having a spreader bar at each of said opposite ends.
